(19) United States
(12) Patent Application Publication
(10) Pub. No.: US 2004/0104103 A1
(43) Pub. Date: Jun. 3, 2004

(54) Conveying path for articles, in particular for baggage containers

(76) Inventor: Michael Kuhn, Hainburg (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/664,593

(22) Filed: Sep. 17, 2003

(30) Foreign Application Priority Data
Sep. 17, 2002 (DE) 102 43 117.5

(51) Int. Cl. B65G 15/14; B65G 39/10

(52) U.S. Cl. 198/842; 198/626.1

(57) ABSTRACT

The invention relates to a conveying path (1) for articles, in particular for baggage containers, having at least two spaced-apart conveyors (2) which bear the articles, run parallel in the conveying direction (F) and of which at least one has a driven, endlessly circulating conveying belt (5) guided over deflecting wheels (9) and by means of which the articles can be carried away on the top side of the top strand (7), with carrying rollers (4) arranged one behind the other, as seen in the conveying direction (F), between the deflecting wheels (9) in order to support the conveying belt (5). In order to minimize the wear of the conveying belt (5) and carrying roller (4), it is proposed that drive means are provided, and these ensure that, even if the top strand (7) is not resting on the carrying roller (4), the circumferential speed of this carrying roller (4) is equal in each case to the running speed of the conveying belt (5).

### BACKGROUND OF THE INVENTION

The invention relates to a conveying path for articles, in particular for baggage containers.

EP 0 802 129 B1 discloses a conveying path for baggage containers which has two spaced-apart conveyors which run parallel in the conveying direction and on which the baggage containers rest, in each case with one side on one conveyor and with the other side on the other conveyor. One of the conveyors has a driven, endlessly circulating conveying belt which is designed as a toothed belt and is guided over deflecting wheels. Located between the deflecting wheels are a plurality of carrying rollers, which are arranged one behind the other and support the conveying belt from beneath during transportation of baggage containers. Arranged on the toothed side of the conveying belt, for guidance purposes, is a crosspiece which extends in the parallel direction of the conveying belt. The deflecting wheels and the carrying rollers each have a radial groove accommodating the crosspiece. The other conveyor is provided with freely rotatable running rollers on which the baggage containers can each rest and roll.

Furthermore, DE 44 07 163 C1 discloses a conveying installation for pallets on which motor vehicles can be set down, this installation likewise essentially comprising two parallel and spaced-apart conveying belts for transporting the pallets. The conveying belts are each of endless circulating design and are guided, at the start and at the end of the conveying path, over deflecting wheels which can be rotated about horizontal axes and of which one, per conveying belt, is driven via an electric motor. The transmission of the driving power between the deflecting wheels and the conveying belt takes place in a frictionally locking manner. The deflecting wheels are mounted in each case at the ends of two parallel longitudinal members running in the conveying direction.

The conveying belts are usually pre-stressed, by at least one of the two deflecting wheels being mounted in a horizontally displaceable manner. This pre-stressing ensures the necessary friction fit for the force transmission between the driven deflecting wheel and the conveying belt. The carrying rollers, which are arranged beneath the top strand, may have an alignment error on account of production tolerances, i.e. the carrying rollers are not always aligned horizontally in this case. This may result, during operation, in the top strand of the conveying belt not butting against the carrying roller if there is no baggage container resting thereon, i.e. the top strand moves in a contactless manner, with a narrow gap being formed in the process, beyond the carrying roller, which then, on account of frictional losses, decreases its speed of revolution, possibly to a standstill. When a baggage container runs into the region of this carrying roller, the conveying belt is pressed against this carrying roller by the baggage container and the carrying roller is accelerated, with a friction fit, until its circumferential speed once again corresponds to the running speed of the conveying belt. This may result in increased wear on the carrying roller and the conveying belt. The effect of the baggage container running out of the region of the carrying roller is the same as the effect when the baggage container runs in. The wear on the carrying roller and conveying belt is greatest when the carrying roller is at a standstill and is accelerated again to the full running speed of the conveying belt.

### SUMMARY OF THE INVENTION

The object of the invention is to specify a conveying path for baggage containers which results in less wear on the conveying belt and carrying roller.

This object is achieved by the features of claim 1. Advantageous configurations of the conveying path are specified in the dependent claims.

The solution provides that drive means are provided, and these ensure that, even if the top strand is not resting on the carrying roller, the circumferential speed of this carrying roller is equal in each case to the running speed of the conveying belt. For the situation where a carrying roller and the top strand of the non-loaded conveying belt do not butt against one another, it is always the case, when the baggage container runs into the region of the carrying roller, that the carrying roller, already rotating at the running speed of the conveying belt, and the moving conveying belt are in contact. On account of the same speeds, the speed relative to one another is equal to zero, with the result that the conveying belt is pressed against the carrying roller without any sliding-friction losses, a static friction fit being formed in the process. Acceleration of the carrying roller no longer takes place.

Straightforwardly designed drive means are obtained if the drive means are designed as pressure-exerting rollers which are arranged parallel to the carrying rollers and press the bottom strand, from beneath in each case, against the carrying rollers, the inside of the bottom strand, which is directed toward the carrying rollers, driving the carrying rollers in a frictionally locking manner. The direction of rotation of the carrying rollers here corresponds to the direction of rotation of the deflecting wheels. The circumferential speed of the carrying rollers is thus always equal to the running speed of the conveying belt.

In order to allow straightforward adjustment of the contact pressure against the carrying rollers, each pressure-exerting roller is arranged between two carrying rollers, as seen in the conveying direction.

Arranging each pressure-exerting roller with an overlap in relation to the carrying roller produces guidance for the bottom strand, this achieving reliable abutment of the inside of the bottom strand against the carrying roller.

Optimum action is achieved by an overlap in which the lowermost vertical height of the circumference of a carrying roller is 5 mm lower than the uppermost vertical height of the circumference of the pressure-exerting roller.

The slippage decreases if the conveying belt used is a toothed belt.

An inexpensive conveying belt is provided if a flat belt is used as the conveying belt.

Driving of the carrying roller is likewise ensured if the carrying roller is designed as a toothed roller corresponding to the toothed belt, the interengaging toothing arrangements acting as drive means. The gap which may be produced between the carrying roller and conveying belt, and is responsible for the wear of the two elements, may be bridged by the projecting teeth of the toothed belt and of the toothed roller. The teeth of the toothed belt engage behind the correspondingly designed teeth of the toothed roller and drive the latter in a slippage-free manner.

Reliable lateral guidance of the toothed belt is provided if the toothed belt, on the toothed side, has a crosspiece which projects from the surface of the conveying belt and runs parallel to the longitudinal extent of the conveying belt. This crosspiece engages in a radial groove corresponding to the crosspiece, and thus prevents lateral displacement.

### BRIEF DESCRIPTION OF THE DRAWINGS

Further advantages and features of the invention can be gathered from the following description with reference to the figures, in which:

FIG. 1 shows a plan view of a conveying path,

FIG. 2 shows a side view of the conveying path according to FIG. 1, and

FIG. 3 shows a sectional illustration of the conveying path according to FIG. 2.

### DETAILED DESCRIPTION OF THE PREFERRED EMBODIMENT

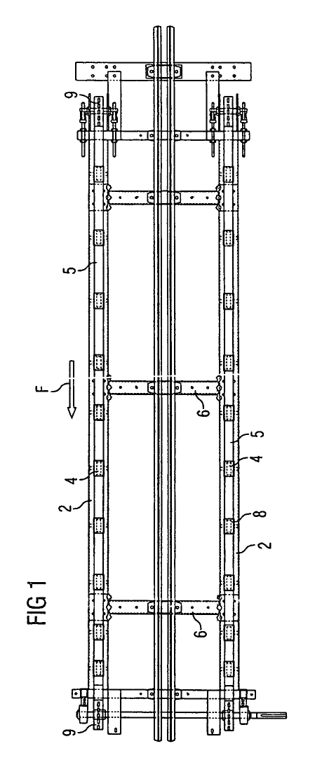

FIG. 1 shows a plan view of a conveying path 1 for articles. The conveying path 1 is designed by two conveyors 2 which bear the articles, are spaced apart from one another by crossmembers 6 and run parallel to the conveying direction F. Arranged on the two conveyors 2 is an endlessly circulating conveying belt 5 which, designed as a flat belt, is guided over deflecting wheels 9. An electric drive (not illustrated) for the conveying belt 5 is connected to one deflecting wheel 9. The conveying belt 5 has a top strand 7 and a bottom strand 10, it being possible for the articles to be carried away on the surface of the top strand 7. Each conveyor is of C-shaped configuration in cross section (see FIG. 3) and, on its side which is directed toward the top strand 7 of the conveying belt 5, has a plurality of openings 8, from which in each case one carrying roller 4 projects. The axes of rotation of the carrying rollers 4 here are arranged parallel to those of the deflecting wheels 9. The carrying rollers 4 are mounted one behind the other, as seen in the conveying direction F. The carrying rollers 4, which are arranged between the deflecting wheels 9, support the top strand 7 of the conveying belt 5 during transportation of articles. They are usually spaced apart from one another, and from the deflecting wheels, by a distance which is smaller than half the length of an article which is to be transported.

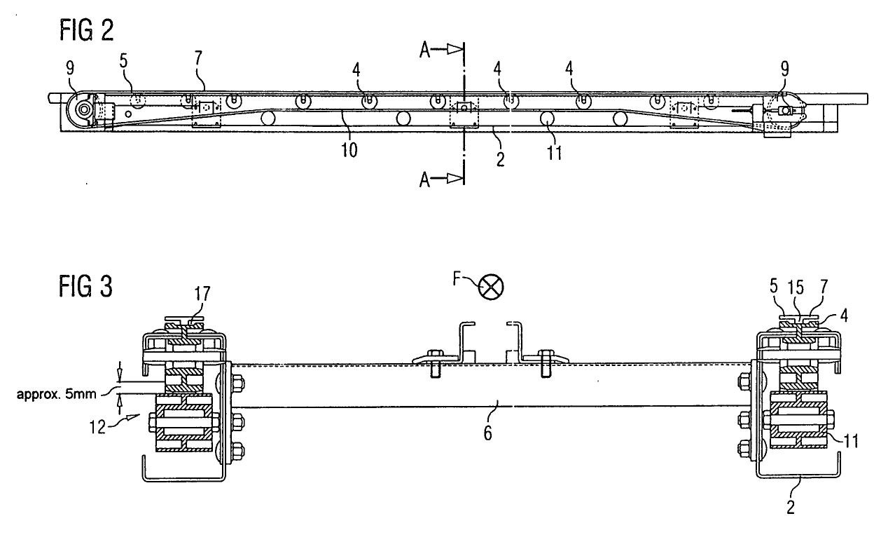

FIG. 2 illustrates the conveying path 1 according to FIG. 1 in a side view. On the horizontally running conveyor 2, the carrying rollers 4 are arranged in the vertical direction between the deflecting wheels 9, and project some way in the upward direction out of the openings 8 of the conveyor 2. Those regions of the carrying rollers 4 on which the conveying belt 5 rests are in alignment between the deflecting rollers 9, with the result that an article which is to be transported is carried away in a single plane. Pressure-exerting rollers 11 are arranged, as drive means, horizontally between the carrying rollers 4 and parallel to the latter, the pressure-exerting rollers guiding the bottom strand 10 in the conveyor 2 such that said bottom strand butts against the underside of at least one carrying roller 4. The pressure-exerting rollers 11 are positioned in the vertical direction such that their highest circumferential point is located above the lowermost circumferential point of a carrying roller 4. This overlap 12 results in a slightly undulating profile of the bottom strand 10.

The forced guidance of the bottom strand 10 by the pressure-exerting rollers 11 means that the bottom strand butts reliably against the carrying rollers 4. This results in the carrying rollers 4 being permanently driven, so that loss-incurring acceleration of the carrying rollers 4 by the top strand 7 is dispensed with. This arrangement can be used for conveying paths 1 which use a flat belt or else a toothed belt, which may also have a circulating crosspiece, as the conveying belts 5.

A section along section line A-A in FIG. 2 is illustrated in FIG. 3. The crossmember 6 connects the two conveyors 2 of the conveying path 1 and spaces them apart. The carrying rollers 4 and the pressure-exerting rollers 11 are arranged on the cross-sectionally C-shaped conveyor 2 with their axes of rotation parallel to one another. A pressure-exerting roller 11 is arranged with an overlap 12 of 5 mm beneath the carrying roller 4. The bottom strand 10 of the conveying belt 5, which runs between the carrying roller 4 and the pressure-exerting roller 11, butts, as an additional drive means of the carrying roller 4, against the latter from beneath. The carrying roller 4, which is intended to bear the top strand 7 of the conveying belt 5, can be seen projecting upward from the conveyor 2.

The conveying belt 5 is configured with a circulating crosspiece 15. The carrying rollers 4 and the deflecting wheels 9 have a radial groove 17, in which the crosspiece 15 of the toothed belt engages and rests. The crosspiece 15 of the conveying belt 5 prevents lateral displacement of the conveying belt 5 in relation to the carrying roller 4. Furthermore, the conveying belt 5 is provided, on the crosspiece side, with teeth in order to be driven in a slippage-free manner by means of one of the deflecting wheels 9, these having a corresponding toothing arrangement for this purpose. The teeth of the conveying belt 5 do not come into contact with the circumferential surfaces of the carrying rollers 4.

Of course, the conveying belt 5 may also be designed as a toothed belt. The teeth of the toothed belt here engage behind the teeth of the carrying rollers 4, which are then configured as toothed rollers (not illustrated), and drive the same. In this case, these form the drive means, which always ensure the desired rotary movement of the carrying rollers 4. Lateral guidance of the toothed belt by means of a crosspiece 15 circulating on the side which is directed toward the carrying rollers 4 is additionally possible. It is then necessary for the toothed rollers and the deflecting wheels 9 to have a radial groove 17, in which the crosspiece 15 is guided.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. A conveying path for articles, in particular for baggage containers, said conveying path comprising:
at least two spaced-apart conveyors which support articles, said at least two spaced-apart conveyors running parallel in a conveying direction, at least one of said conveyors having a driven endlessly circulating conveying belt guided over deflecting wheels wherein the articles can be carried on a top side of a top strand of said conveying belt;
carrying rollers arranged one behind the other in the conveying direction, between the deflecting wheels in order to support the conveying belt;
a drive, said drive causing the circumferential speed of this carrying roller to equal the running speed of the conveying belt even if the top strand is not resting on the carrying roller.

2. The conveying path as claimed in claim 1 wherein said drive comprises pressure-exerting rollers which are arranged parallel to said carrying rollers and press a bottom strand of said conveying belt in a frictionally locking manner, from beneath against said carrying rollers.

3. The conveying path as claimed in claim 2, wherein each of said pressure-exerting rollers is arranged between said carrying rollers as seen in the conveying direction.

4. The conveying path as claimed in claim 3, wherein each of said pressure-exerting roller is arranged with an overlapping relationship to said carrying roller.

5. The conveying path as claimed in claim 4, wherein the overlap of each of said pressure-exerting rollers in relation to said carrying roller is 5 mm.

6. The conveying path as claimed in claim 1, wherein said conveying belt comprises a flat belt.

7. The conveying path as claimed in claim 1, wherein said conveying belt comprises a toothed belt.

8. The conveying path as claimed in claim 7, wherein said carrying rollers comprise toothed rollers corresponding to said toothed belt, whereby engagement between said toothed belt and said toothed rollers ensure that said carrying rollers are positively driven.

9. The conveying path as claimed in claim 8, wherein a toothed side of said toothed belt has a crosspiece which projects from a surface of said conveying belt and runs parallel to a longitudinal dimension of said conveying belt, wherein articles may be carried on a non-toothed side of said toothed belt.

10. The conveying path as claimed in claim 7, wherein a toothed side of said toothed belt has a crosspiece which projects from a surface of said conveying belt and runs parallel to a longitudinal dimension of said conveying belt, wherein articles may be carried on a non-toothed side of said toothed belt.

11. The conveying path as claimed in claim 2, wherein said conveying belt comprises a flat belt.

12. The conveying path as claimed in claim 3, wherein said conveying belt comprises a flat belt.

13. The conveying path as claimed in claim 4, wherein said conveying belt comprises a flat belt.

14. The conveying path as claimed in claim 5, wherein said conveying belt comprises a flat belt.
